(19) United States
(12) Patent Application Publication
(10) Pub. No.: US 2024/0045062 A1
(43) Pub. Date: Feb. 8, 2024

(54) AUGMENTED ILLUMINATION AND 3D DIMENSIONING (AI3D) FROM 3D RECONSTRUCTION WITHIN A SINGLE-POSE IMAGE

(71) Applicant: KIHOMAC, Inc., Vienna, VA (US)

(72) Inventor: Brian Stearmer, Vienna, VA (US)

(21) Appl. No.: 18/142,134

(22) Filed: May 2, 2023

Related U.S. Application Data
(60) Provisional application No. 63/395,760, filed on Aug. 5, 2022.

(51) Int. Cl. G01S 17/42; G06V 10/44; H04N 23/695

(52) U.S. Cl. CPC G01S 17/42; G06V 10/44; H04N 23/695; G06V 2201/07; G06V 2201/121

(57) ABSTRACT

A bridge military load classification (MLC) assessment system may increase soldier survivability and/or engineer reconnaissance support to military decision-making process (MDMP) while reducing the required operator level of expertise. A set of “at distance” 3D dimensioning solutions may include soldier-guided, vector-based measurements, photogrammetry, and/or computer vision (CV) and augmented reality (AR) methodologies-enabling off image plane measurements along all three axes across the image through the image principal point. The solutions may include (1) single image with view of bridge feature that introduces two- or three-point perspective, (2) camera focal length, (3) camera sensor width, (4) laser rangefinder (LRF) vector to the image principal point, and (5) two lines traced along edges of the bridge to identify one vanishing point. A rapid MLC could be calculated from a considerable distance (greater than 100 meters) given an unobstructed “below-deck” view of the bridge.

### CROSS-RELATED TO RELATED APPLICATION

The present Application is a non-provisional of, and claims priority to, U.S. Patent Application No. 63/395,760 filed Aug. 5, 2022, the disclosure of which is incorporated by reference in its entirety.

### FIELD OF THE DISCLOSURE

The present disclosure generally relates measuring length, thickness, or similar dimension, and more particularly, to measuring arrangements characterized by optical means.

### BACKGROUND

Operational and training factors often lead to denial, incomplete and/or misinformation surrounding Army combat engineer bridge load capacity assessments. They need to be able to take very accurate measurements of bridge objects from safe distances. Making measurements of key buildings and infrastructure, such as bridges, from an image could be a useful method. However, current photogrammetry solutions enable measurements only across an image plane (or the objects represented on the image plane). Current computer vision solution sets do not enable dimensioning of extremely noisy images (object classification or edge detection). Current three-dimensional (3D) reconstruction (sometimes referred to as digital twin creation) methods primarily solve object identification with at least two clear perpendicular sets of parallel lines or structure from motion techniques requiring multiple images from different locations of the same object(s). While structure from motion techniques requiring multiple images from different locations of the same object(s), operational, and/or environmental constraints of engineering reconnaissance will reduce or block an engineer's freedom of movement to gather enough images.

### SUMMARY

Embodiments of the present disclosure may provide an at-distance measurement system. The current use case example is incorporated within a bridge military load classification (MLC) assessment system that may increase soldier survivability and/or engineer reconnaissance support to military decision-making process (MDMP) while reducing the required operator level of expertise. Embodiments of the present disclosure may provide a set of “at distance” 3D dimensioning solutions. The set of solutions include soldier-guided, vector-based measurements, photogrammetry, and/or computer vision (CV) and augmented reality (AR) methodologies-enabling off image plane measurements along all three axes across the image through the image principal point. The solutions may include (1) single image with view of bridge feature that introduces two- or three-point perspective, (2) camera focal length, (3) camera sensor width, (4) laser rangefinder (LRF) vector (range, azimuth, and inclination) to the image principal point, and (5) two lines traced along edges of the bridge to identify one vanishing point. Using embodiments of the present disclosure, a rapid MLC could be calculated from a considerable distance (greater than 100 meters) given an unobstructed “below-deck” view of the bridge.

A soldier may take an image of the bridge, and the interface may identify the principal point of the image. An LRF shot to the principal point may be taken. Two lengthwise edges of the bridge may be traced, and the interface may present an axis and measurement-dependent measurement from one of the three vanishing points through the principal point. Other bridge features may be measured. One image may not have a view of all of the bridge features set forth in the bridge reconnaissance doctrine, and these steps may be repeated until the required bridge features are photographed and measured.

Five major inputs may be used to perform these tasks. First, with a single image with a view of bridge features, embodiments of the present disclosure may identify and enable two or three-point perspective image measurements. Second, the camera focal length may be pulled from the Exchangeable Image File (EXIF). Third, camera sensor width is usually not included within the EXIF data but is published within the manufacture specifications. Fourth, one laser rangefinder vector (received in range, azimuth, and inclination format) to the image's principal point may be input. Finally, the user and/or an automated means may trace a line along two edges of the bridge, which will identify the location (on or off image) of one vanishing point.

By using embodiments of the present disclosure, a soldier can measure bridge features and condition at distance to calculate a rapid MLC. With the current fielded camera zoomed in fully, pixel size at 100 meters would be 0.22 inches. Given that an object needs to occupy two pixels for a human eye to distinguish it from other objects—this would likely enable the user to distinguish objects 0.44 inches or larger at 100 meters. The smallest bridge feature required for measurement is a steel stringer (or girder) flange thickness, which can vary from 0.25 to 1.25 inches. Even with the current hardware constraints, MLC assessments can be calculated from a considerable distance (often greater than 100 meters) given an unobstructed “below-deck” view of the bridge.

Embodiments of the present disclosure may provide a method for augmented illumination and three-dimensional dimensioning (AI3D) comprising: photographing an image of one or more key buildings and/or infrastructure, wherein an interface identifies a principal point of the image; capturing a laser rangefinder (LRF) shot to the principal point of the image; tracing two lengthwise edges of the one or more key buildings and/or infrastructure, wherein the interface presents an axis-dependent measurement tool from one of a plurality of vanishing points through the principal point; and measuring one or more features of the one or more key buildings and/or infrastructure. The steps may be repeated until each of the one or more features are photographed, captured, and measured. The method also may comprise using a global positioning system (GPS) to add location information with respect to the one or more features of the one or more key buildings and/or infrastructure. The LRF shot may include binary vector values transmittable via a data transfer protocol. The binary vector values may be selected from the group comprising: slope distance, azimuth, and/or inclination. The measuring step may determine a linear field of view in a world space, an image plane pixel resolution in the world space, and/or a conversion scale between a sensor space and the world space. The conversion scale may validate a quality of measurement of a camera reported focal length and sensor width. The plurality of vanishing points may be two located on a horizon line and a third vanishing point either at a zenith or a nadir. The method also may comprise creating an Exchangeable Image File (EXIF) dictionary using the measurements. The EXIF dictionary also may include sensor width, direct input, sensor height, direct input, pixel width, sensor space, and/or principal point (p) x/y coordinates.

Other embodiments of the present disclosure may provide a augmented illumination and three-dimensional dimensioning (AI3D) system comprising: a single-pose image with view of a feature of a key building and/or infrastructure that identifies two- or three-point perspective image measurements; a camera focal length pulled from an Exchangeable Image File (EXIF); a camera sensor width; a laser rangefinder (LRF) vector to a principal point of the single image; and two lines traced along edges of the key building and/or infrastructure to identify a location of at least one vanishing point. The LRF vector may be received in range, azimuth, and inclination format. The EXIF data may contain the camera focal length, number of pixels per image width and height, sensor width, direct input, sensor height, direct input, pixel width, sensor space, and/or principal point (p) x/y coordinates. The at least one vanishing point may be identified from the following: panning left or right (azimuth) from the two lines traced along stringers; and tilting up or down (inclination) from the two lines traced along the stringers. The at least one vanishing point may include two located on a horizon line and a third either at a zenith or a nadir. Horizontal perpendicular lines to the stringers may be representative of at least bridge width and stringer spacing. Vertical perpendicular lines to the stringers may be representative of at least stringer height and deck thickness. The system also may comprise a global positioning system (GPS) to add location information with respect to the key building and/or infrastructure.

### BRIEF DESCRIPTION OF THE DRAWINGS

For a more complete understanding of this disclosure, reference is now made to the following description, taken in conjunction with the accompanying drawings, in which:

FIG. 1 depicts a device and inputs according to an embodiment of the present disclosure;

FIG. 2 depicts LRF distance (Z-axis) and azimuth according to an embodiment of the present disclosure;

FIG. 3 depicts LRF range and inclination according to an embodiment of the present disclosure;

FIG. 4 depicts camera roll, tilt, and pan according to an embodiment of the present disclosure;

FIG. 5 depicts an image plane according to an embodiment of the present disclosure;

FIG. 6 depicts an image plane placement according to an embodiment of the present disclosure;

FIG. 7 depicts an image plane placement of VP2 according to an embodiment of the present disclosure;

FIG. 8 depicts an image plane transposition to vanishing point plane along N according to an embodiment of the present disclosure; and

FIG. 9 depicts off-image plane measurement (3D reconstruction) for line placement according to an embodiment of the present disclosure.

### DETAILED DESCRIPTION

Embodiments of the present disclosure may provide augmented illumination and three-dimensional dimensioning (AI3D) from 3D reconstruction within a single-pose image. AI3D is a system that may give an operational advantage due to at-distance measurements from one (single-pose) image. AI3D may provide automation to find the second vanishing point, augmented illumination of the lines from the vanishing points (perpendicular lines) across the image plane, 3D reconstruction of off-image plane objects by a transposition of image coordinates onto a vanishing point dependent plane, and/or apply scale and related dimensions of off-image plane objects along all three axes of orientation.

AI3D according to embodiments of the present disclosure may include at least the following: (1) single image with view of bridge feature that introduces two- or three-point perspective; (2) camera focal length; (3) camera sensor width; (4) laser rangefinder (LRF) vector (range, azimuth, and inclination) to image principal point; and/or (5) one identified vanishing point. A soldier or other user may (1) take an image of the bridge, where the interface may identify the principal point of the image; (2) take an LRF shot to the image principal point; (3) trace two lengthwise edges of the bridge, where the interface may present an axis dependent measurement tool from one of the three vanishing points through the principal point; and (4) measure required bridge features. It should be appreciated that one image may not have a view of all the bridge features needing to be measured as outlined in the Army bridge reconnaissance doctrine. This process may need to be, and can be, repeated until all required bridge features are photographed and measured.

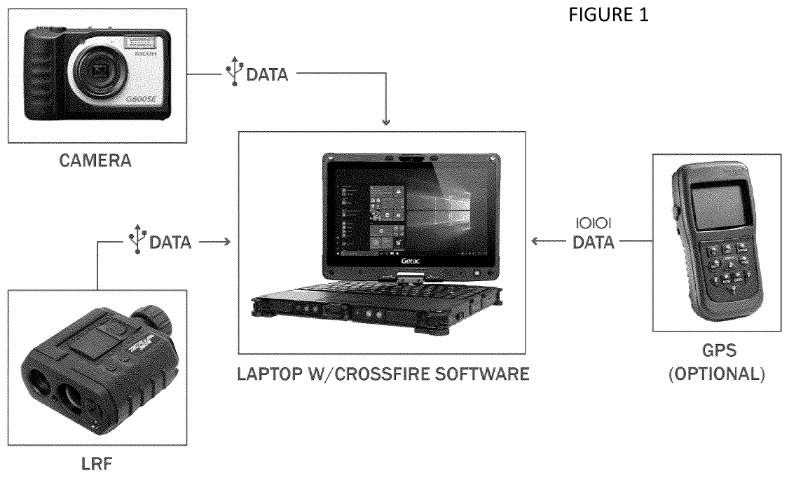

To complete the computer vision solution, the user must have access to a camera, a laser range finder (LRF), and a laptop (or combination of those systems) as depicted in FIG. 1. The camera and/or LRF may provide data to the laptop or other computing device that may be used. Use of GPS may add location information to the overall bridge assessment but is not needed for measurement of bridge features by the AI3D system in embodiments of the present disclosure.

The image exchangeable image file format (EXIF) data may contain the focal length and number of pixels per image width and height. The image sensor width and height may be found in manufacturer documentation for the camera being used. Digital camera sensor sizes may be ascertained, and an approximation may be made by (Resolution in pixels/Focal plane resolution in dots per inch (dpi))*25.4(mm/in)=size in mm. However, it should be appreciated that the dpi found in the EXIF often may be a fixed value more related to printing than actual sensor dots per inch values.

The image calculations may be completed within the image coordinate space with the point of origin (0,0) being the bottom left of the image. The image may be referenced in sensor space, or distance measurements in millimeters as compared to the camera's imaging sensor. In an embodiment of the present disclosure, a JPEG file may be uploaded, and a file object may be imported in an uploader widget into a Python Pillow object. Key values may be added to the image's EXIF data to a Python dictionary object, and a dictionary of the EXIF data may be created. Data may include sensor width in mm, direct input (may not be in EXIF), sensor height in mm, direct input (may not be in EXIF), pixel width in mm, sensor space, and/or principal point (p) x/y coordinates.

Distance calculations from images captured on the surface of the Earth differ from typical air- or space-borne platform images because objects in the image are not easily tied to measurements across an image. In typical air- or space-borne platform images, calculating measurements between objects on the ground may be enabled because of the close approximation between the objects and the image plane. Objects depicted in a surface-based image will have very little approximation between the objects and the image plane. AI3D takes advantage of linear properties of bridges because they will introduce perspective. Perspective within a single-pose image on the surface of the Earth introduces an illusion of parallel features (lines) converging to at least one vanishing point. When a vanishing point is located at the image principal point (p), there will be only one vanishing point and is called single-point perspective. This situation would be problematic for the AI3D solution when distance-to-p equals co because the math would be undefined. However, that would also imply the camera is centered with the bridge (looking through it and towards the horizon) and the bridge maintains parallel lines to the horizon (like a railroad track). The camera operator typically will not be in the middle of traffic and nearly all bridges are well short of the required distance for that type of scenario making (nearly) all bridge images having more than single-point perspective.

Camera orientation can have three axes of rotation: tilt (LRF inclination), pan (LRF azimuth) and roll (horizon line). Panning left or right (azimuth) from lines traced along the stringers introduces another vanishing point. The horizontal perpendicular lines to the stringers are representative of bridge width, stringer spacing, etc. Tilting up or down (inclination) from lines traced along the stringers introduces another vanishing point. The vertical perpendicular lines to the stringers are representative of stringer height, deck thickness, etc.

Finding the orientation of bridge features in relation and approximation to the image plane is a function of finding the location of the vanishing points. Tracing and extending lines along linear features of a bridge in an image will easily find one vanishing point. However, these are images not typical of a “Manhattan World” (https://www-users.cs.umn.edu/˜stergios/papers/ICCV-11-DLSVanishingPoints.pdf). Finding the location of the second vanishing point is often not possible given what can be seen in the image. Often, any bridge feature that would trace to other vanishing points are blocked or obscured by environment or shadows. Throughout AI3D, a core function is calculating the placement of the other vanishing points.

A Python plot according to embodiments of the present disclosure may be interactive and may allow the user to trace (plot) lines along bridge features, like stringers. The user may click on the start and end of two linear features. Each click makes an onclick event (a point) and puts it in a python data structure called a dictionary. An intersection point of convergent lines (the first vanishing point) may be calculated.

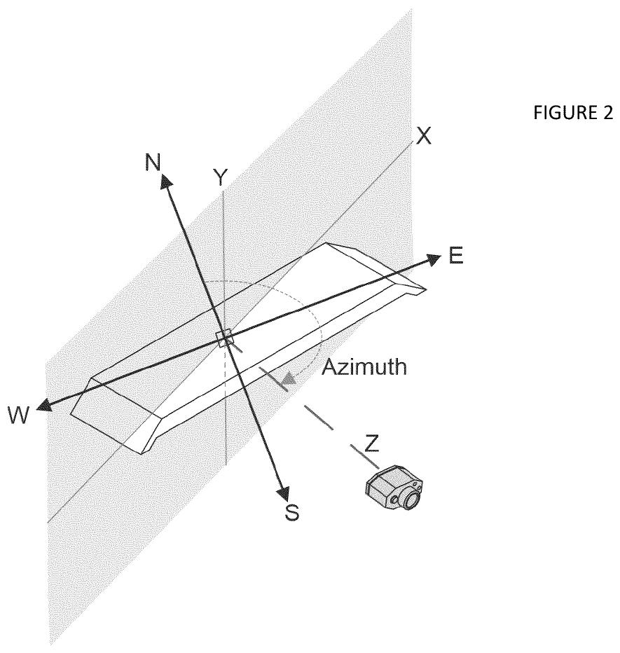

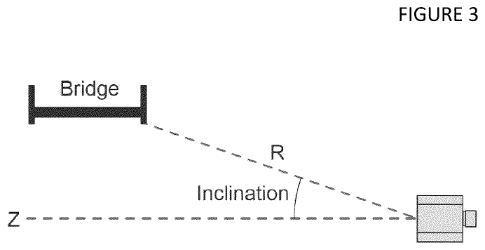

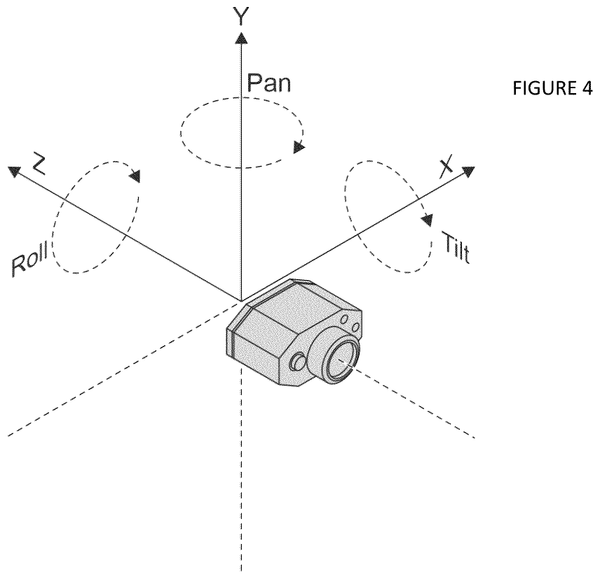

The LRF may transmit binary vector values via a data transfer protocol to the AI3D software. Vector values may include the slope distance (i.e., range), the azimuth (i.e., cardinal direction), and the inclination (i.e., tilt). FIG. 2 depicts LRF distance (Z-axis) and azimuth according to an embodiment of the present disclosure, and FIG. 3 depicts LRF range and inclination according to an embodiment of the present disclosure. FIG. 4 depicts camera roll, tilt, and pan according to an embodiment of the present disclosure.

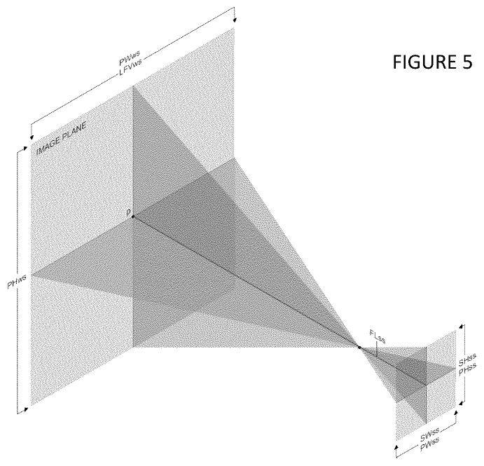

Measurements from the image plane may be used to calculate the linear field of view in the world space (width of the image plane), the image plane pixel resolution in world space, and the conversion scale between sensor space and world space. Primarily, the scale of the image plane is important for world space measurements across the image plane. Secondly, a scale function of the range may be performed to validate the quality of measurement of the camera reported focal length and sensor width. FIG. 5 depicts an image plane according to an embodiment of the present disclosure.

A camera panning away (to the left or right) from the first vanishing point may introduce a second vanishing point along the horizon line (eye level line). Both vanishing points may be located on the horizon line. Finding the orientation of features that pass through the image plane in the X and Z axis may enable a more representative calculation of lengths. Features that pass through the principal point in the Y axis will have the same scale as the image plane. See, e.g., FIG. 2.

A camera panning (left or right) and tilting (up or down) from the vanishing point may introduce two more vanishing points. Two may be located on the horizon line (“eye level” and the third may be either at the zenith (above-positive inclination) or the nadir (below-negative inclination). Like two-point perspective, finding the orientation of features that pass through the image plane may enable a more representative calculation of lengths. However, in three-point perspective, an object may have a measure of orientation through all three axes of the image plane. See, e.g., FIG. 2.

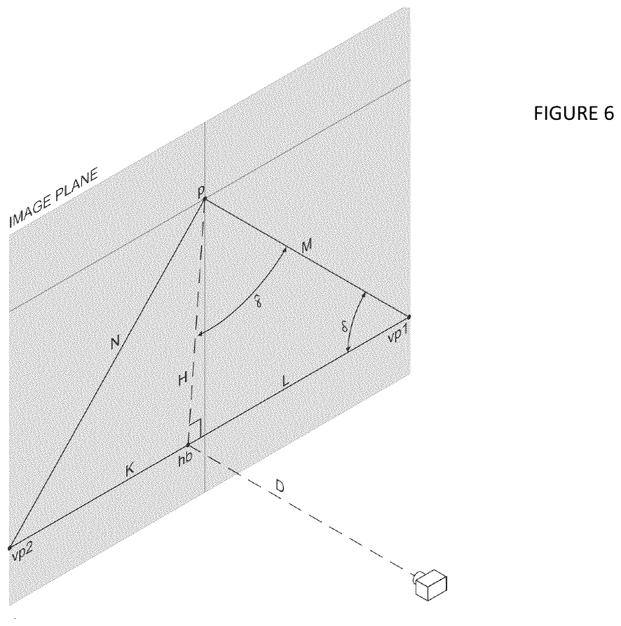

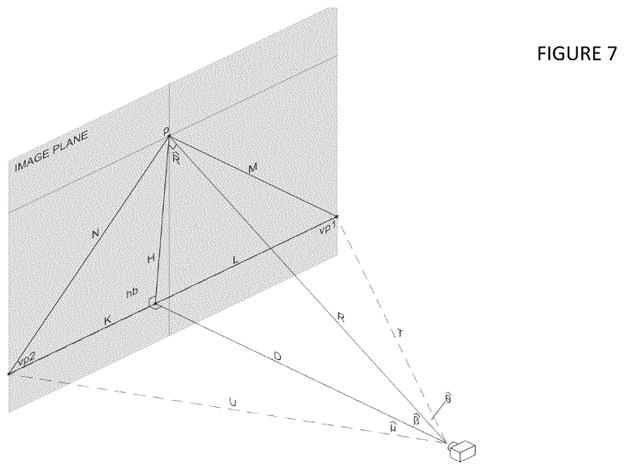

FIG. 6 depicts an image plane placement according to an embodiment of the present disclosure. H is the line segment between the principal point and perpendicular to the horizon line (line between VP1 and VP2). A perspective projection may be used to calculate x/y coordinates of bottom point of H. The coordinates where H intersects with the horizon line may be used to calculate the coordinates of VP2 by extending line L. The length of H is a trigonometric function of angle of inclination. Once the slope of L (and by extension, the slope of K) have been determined, the length of K may be calculated to calculate the location of the second vanishing point. This may be done by utilizing the properties of the convergent lines. A theoretical convergent line parallel to M may come from VP1 to the camera. Another theoretical convergent line parallel to N may come from VP2 to the camera. These two convergent lines are also perpendicular to each other and will form a right angle at the camera. Thus, by calculating the angle from VP1 to hb, the angle to VP2 may be determined. FIG. 7 depicts an image plane placement of VP2 according to an embodiment of the present disclosure.

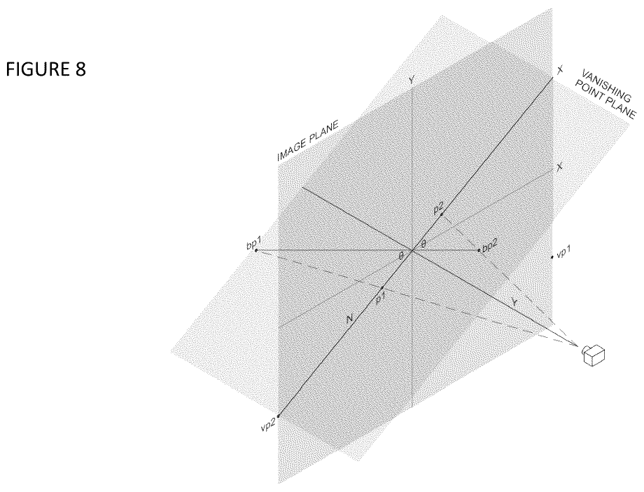

Calculating measurements on the image plane to off-image plane objects is a function of the orientation of the object. FIG. 8 depicts an image plane transposition to vanishing point plane along N according to an embodiment of the present disclosure. This depicts a 3D reconstruction or transposition from the image plane to a vanishing point plane that may work in two- and three-point perspectives. The feature must be linear and fall on a line that traverses through principal point. The corresponding vanishing point will orient the line across the vanishing point plane. Planes can be defined by two lines in three-dimensional space. The transposition of image plane points (x/y values) to a plane along lines from one of the three vanishing points (vp1, vp2 or vp3) to p (first line) and camera to p (second line). p is the origin point in this new coordinate plane. p1 and p2 are the end points of the measured line segment on the image plane, with |p1x| is the sensor space slope distance to p and ply is zero. bp1 and bp2 are the end points of the representative line segment in three-dimensional space.

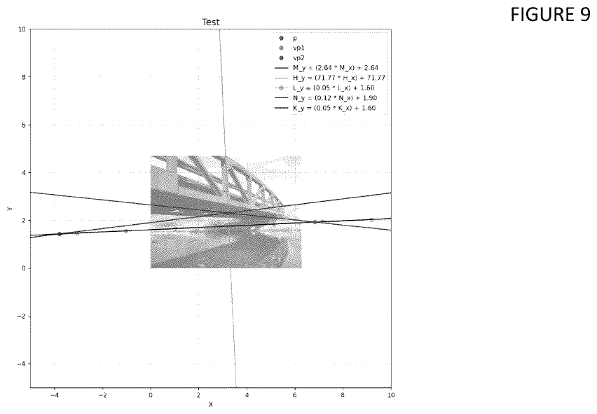

FIG. 9 depicts off-image plane measurement (3D reconstruction) for line placement according to an embodiment of the present disclosure. The user may select the start and end points of a feature to be measured along the three axes of orientation of the object M, N or H.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for augmented illumination and three-dimensional dimensioning (AI3D) comprising:
photographing an image of one or more key buildings and/or infrastructure, wherein an interface identifies a principal point of the image;
capturing a laser rangefinder (LRF) shot to the principal point of the image;
tracing two lengthwise edges of the one or more key buildings and/or infrastructure, wherein the interface presents an axis-dependent measurement tool from one of a plurality of vanishing points through the principal point; and
measuring one or more features of the one or more key buildings and/or infrastructure.

2. The method of claim 1, wherein the steps are repeated until each of the one or more features are photographed, captured, and measured.

3. The method of claim 1 further comprising:
using a global positioning system (GPS) to add location information with respect to the one or more features of the one or more key buildings and/or infrastructure.

4. The method of claim 1, wherein the LRF shot includes binary vector values transmittable via a data transfer protocol.

5. The method of claim 4, wherein the binary vector values are selected from the group comprising:
slope distance, azimuth, and/or inclination.

6. The method of claim 1, wherein the measuring step determines a linear field of view in a world space, an image plane pixel resolution in the world space, and/or a conversion scale between a sensor space and the world space.

7. The method of claim 6, wherein the conversion scale validates a quality of measurement of a camera reported focal length and sensor width.

8. The method of claim 1, wherein the plurality of vanishing points are two located on a horizon line and a third vanishing point either at a zenith or a nadir.

9. The method of claim 1 further comprising:
creating an Exchangeable Image File (EXIF) dictionary using the measurements.

10. The method of claim 9, the EXIF dictionary further comprising:
sensor width, direct input, sensor height, direct input, pixel width, sensor space, and/or principal point (p) x/y coordinates.

11. An augmented illumination and three-dimensional dimensioning (AI3D) system comprising:
a single-pose image with view of a feature of a key building and/or infrastructure that identifies two- or three-point perspective image measurements;
a camera focal length pulled from an Exchangeable Image File (EXIF);
a camera sensor width;
a laser rangefinder (LRF) vector to a principal point of the single image; and
two lines traced along edges of the key building and/or infrastructure to identify a location of at least one vanishing point.

12. The system of claim 11, wherein the LRF vector is received in range, azimuth, and inclination format.

13. The system of claim 11, wherein EXIF data contains the camera focal length, number of pixels per image width and height, sensor width, direct input, sensor height, direct input, pixel width, sensor space, and/or principal point (p) x/y coordinates.

14. The system of claim 11, wherein the at least one vanishing point is identified from the following:
panning left or right (azimuth) from the two lines traced along stringers; and
tilting up or down (inclination) from the two lines traced along the stringers.

15. The system of claim 11, wherein the at least one vanishing point include two located on a horizon line and a third either at a zenith or a nadir.

16. The system of claim 13, wherein horizontal perpendicular lines to the stringers are representative of at least bridge width and stringer spacing.

17. The system of claim 13, wherein vertical perpendicular lines to the stringers are representative of at least stringer height and deck thickness.

18. The system of claim 11 further comprising:
a global positioning system (GPS) to add location information with respect to the key building and/or infrastructure.
